(19) United States
(12) Patent Application Publication
(10) Pub. No.: US 2015/0372298 A1
(43) Pub. Date: Dec. 24, 2015

(54) ALL-SOLID STATE ION SECONDARY BATTERY

(71) Applicant: HITACHI, LTD., Tokyo (JP)

(72) Inventors: Tadashi FUJIEDA, Tokyo (JP); Jun KAWAJI, Tokyo (JP); Takuya AOYAGI, Tokyo (JP); Takashi NAITO, Tokyo (JP)

(73) Assignee: HITACHI, LTD., Tokyo (JP)

(21) Appl. No.: 14/765,174

(22) PCT Filed: Feb. 26, 2013
(86) PCT No.: PCT/JP2013/054836

§ 371 Date: Jul. 31, 2015

(51) Int. Cl. H01M 4/48; H01M 10/0562

(52) U.S. Cl. CPC H01M 4/48; H01M 10/0562; H01M 2300/0071

(57) ABSTRACT

An object of the present invention is to enhance energy density and output density of an all-solid state ion secondary battery. To achieve the object, the present invention provides an all-solid state ion secondary battery in which a solid electrolyte layer is joined between a positive electrode active material layer and a negative electrode active material layer, characterized in that at least one of the positive electrode active material layer and the negative electrode active material layer is formed by binding active material particles and solid electrolyte particles together through an ion-conductive and ferroelectric substance.

### TECHNICAL FIELD

The present invention relates to an all-solid state ion secondary battery.

### BACKGROUND ART

All-solid state ion secondary batteries in which an incombustible or fire-retardant inorganic solid electrolyte is used can be enhanced in thermal resistance and can be made intrinsically safe. In such all-solid state ion secondary batteries, therefore, module cost can be lowered, and energy density can be enhanced.

The all-solid state ion secondary battery as above, however, is disadvantageous in that it is impossible to obtain a sufficient output density or a sufficient energy density, due to a high resistance to ion movements across interfaces between active material particles and solid electrolyte particles. The reasons for the high resistance to ion movements across the interfaces between the active material particles and the solid electrolyte particles are considered as follows: (1) The active material particles and the solid electrolyte particles are in point contact, so that there are few ionic conduction paths. (2) A potential difference between the active material particle and the solid electrolyte particle at the interface between the active material particle and the solid electrolyte particle produces a local electric field, whereby a space-charge layer or an electric double layer is formed, so that an electrochemical potential gradient of ions is reduced.

Patent Document 1 discloses a solid electrolyte battery so designed as to increase the area of contact between active material particles and a solid electrolyte. The solid electrolyte battery includes: a one polarity side electrode including a porous structure of active material particles and a particle binding material; a solid electrolyte layer including an ion-conductive material which coats surfaces of voids in the porous structure; and an other polarity side electrode including an other active material and a filling material which fills the voids in the porous structure.

### PRIOR ART DOCUMENTS

### Patent Document

Patent Document 1: JP-2001-243984-A

### SUMMARY OF THE INVENTION

### Problem to be Solved by the Invention

The solid electrolyte battery disclosed in the above-mentioned patent document, however, leaves a room for further improvement in regard of increasing the area of contact between the active material particles and the solid electrolyte layer. Besides, the patent document does not contain a consideration about the potential difference at the interfaces between the active material particles and the electrolyte particles.

It is an object of the present invention to enhance energy density and output density of an all-solid state ion secondary battery.

### Means for Solving the Problem

To solve the above problem in accordance with the present invention, there is provided an all-solid state ion secondary battery including a solid electrolyte layer joined between a positive electrode active material layer and a negative electrode active material layer, characterized in that at least one of the positive electrode active material layer and the negative electrode active material layer is formed by binding active material particles and solid electrolyte particles through an ion-conductive and ferroelectric substance.

### Effect of the Invention

According to the present invention, energy density and output density of an all-solid state ion secondary battery can be enhanced.

### BRIEF DESCRIPTION OF THE DRAWINGS

FIG. 1 is a sectional view of a major part of an all-solid state ion secondary battery according to a first embodiment of the present invention.

In FIG. 2, (a) is a sectional view of a major part of an all-solid state ion secondary battery according to a second embodiment of the present invention, (b) is an enlarged view of a positive electrode active material layer, and (c) is an enlarged view of a negative electrode active material layer.

### MODES FOR CARRYING OUT THE INVENTION

A first embodiment (Example) of the present invention will be described in detail below, referring to the drawings as required. Note that the present invention is not limited to the individual ones of the plurality of embodiments (Examples) taken up below, and the embodiments may be combined with each other as required.

To enhance output density and energy density of an all-solid state battery, it is necessary to secure sufficient ionic conduction paths between active material particles and solid electrolyte particles, thereby enhancing ion conductivity, and to restrain the formation of a space-charge layer or an electric double layer, thereby enlarging an electrochemical potential gradient of ions. In view of this, it was contemplated to mix the active material particles and the solid electrolyte particles and to fill the gaps between the two kinds of particles with an ion-conductive and ferroelectric vanadium oxide glass. In other words, the active material particles and the solid electrolyte particles are made to present mixedly, and they are bound to each other by the vanadium oxide glass, to form an electrode active material layer. Under the condition where surfaces of the active material particles in contact with the vanadium oxide glass are serving as ionic conduction paths, ions move between the active material particles and the vanadium oxide glass. Further, under the condition where surfaces of the solid electrolyte particles in contact with the vanadium oxide glass are serving as ionic conduction paths, ions move between the vanadium oxide glass and the solid electrolyte particles. As a result, sufficient ionic conduction paths can be secured between the active material particles and the solid electrolyte particles, and ion conductivity can be enhanced. Furthermore, the ferroelectricity of the vanadium oxide glass restrains the formation of a space-charge layer or an electric double layer at interfaces between the active material particles and the solid electrolyte particles, whereby an electrochemical potential gradient of ions can be enlarged, and, hence, the ion conductivity is enhanced.

When the aforementioned configuration is applied to either the positive electrode active material layer or the negative electrode active material layer, the ion conductivity between the positive (or negative) electrode active material particles and the solid electrolyte particles is enhanced, so that the all-solid ion secondary battery is enhanced in energy density and output density. When the aforementioned configuration is applied to both the positive electrode active material layer and the negative electrode active material layer, the ion conductivities between the positive electrode active material particles and the solid electrolyte particles and the negative electrode active material particles are enhanced, so that the battery is further enhanced in energy density and output density. In addition, since the vanadium oxide glass is softened to be fluid at a low temperature of not more than 500° C. at which temperature the active material particles and the solid electrolyte particles do not react with each other, a sintered compact having high density can be easily obtained.

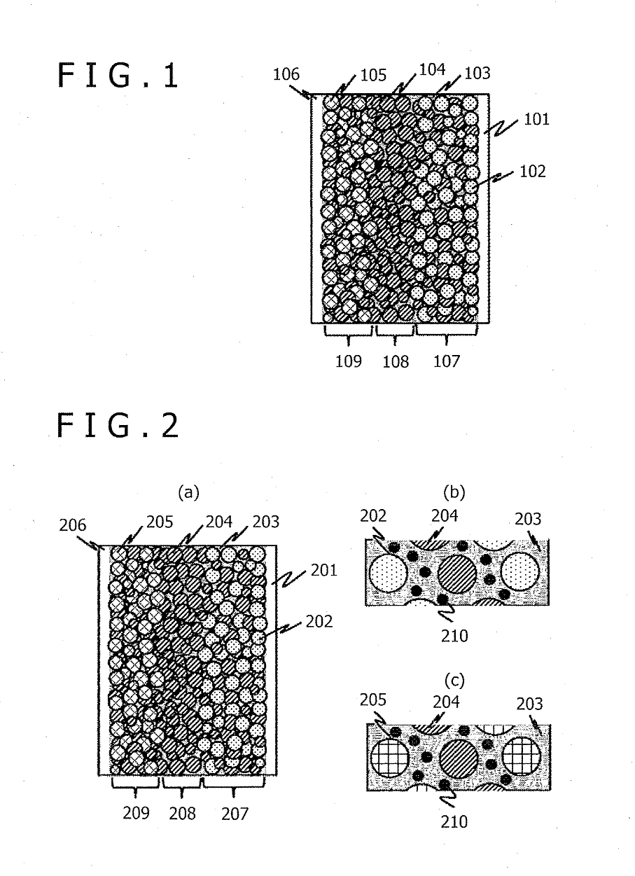

FIG. 1 shows a sectional view of a major part of an all-solid state ion secondary battery according to a first embodiment of the present invention. A positive electrode active material layer 107 formed on a positive electrode collector 101 and a negative electrode active material layer 109 formed on a negative electrode collector 106 are joined to each other through a solid electrolyte 108. Numeral 102 denotes positive electrode active material particles, 103 denotes a vanadium oxide glass, 104 denotes solid electrolyte particles, and 105 denotes negative electrode active material particles.

Note that the positive electrode active material layer and the negative electrode active material layer are perfectly electrically insulated from each other by the solid electrolyte layer.

Note that a conductive assistant may be added, in order to enhance conductivity in the active material layer of each electrode. Where the vanadium oxide glass as a binder between the active material particles and the solid electrolyte particles is crystallized to thereby enhance the conductivity of the active material layer(s), the conductive assistant may be omitted. Preferable examples of the conductive assistant include carbon materials such as graphite, acetylene black, Ketjen black, etc., powders of metal such as gold, silver, copper, nickel, aluminum, titanium, etc., and conductive oxides such as indium tin oxide (ITO), titanium oxide, tin oxide, zinc oxide, tungsten oxide, etc.

The vanadium oxide glass contains at least one of tellurium and phosphorus and at least one selected from the group consisting of titanium, barium, bismuth, tantalum, niobium, zirconium, lead, and iron, and is ferroelectric. To prevent a reaction between the active material particles and the solid electrolyte particles, it is preferable that the softening point of the vanadium oxide glass is not more than 500° C.

The amount of the vanadium oxide glass added according to the amount of the active material or the solid electrolyte, by volume, is desirably not less than 5 vol % and not more than 40 vol %. When the addition amount is not less than 5 vol %, gaps between the active material particles and the solid electrolyte particles can be sufficiently filled up. When the addition amount is not more than 40 vol %, charge/discharge capacity and charge/discharge rate can be prevented from being lowered due to reductions in the amount of the active material and the amount of the solid electrolyte.

In addition, by crystallizing at least part of the vanadium oxide glass in the positive electrode active material layer, it is possible to enhance ion conductivity and electron conductivity. Furthermore, it is possible to precipitate a ferroelectric crystal. Examples of the ferroelectric crystal include BaTiO₃, SrBi₂Ta₂O₉, (K, Na) TaO₃, (K, Na)NbO₃, BiFeO₃, Bi(Nd, La)TiO, and Pb(Zr, Ti)O₃, and are not specifically restricted.

As the positive electrode active material, there can be used any known positive electrode active material that is capable of occlusion and release of lithium ions. Examples of such positive electrode active material include those based on spinel, olivine, laminar oxide, solid solution, silicate or the like. Besides, the vanadium oxide glass can be used as the positive electrode active material, and by crystallizing at least part of the glass it is possible to enhance ion conductivity and electron conductivity. Where the vanadium oxide glass is used also as the positive electrode active material in the positive electrode active material layer, it is unnecessary to impart ferroelectricity to the vanadium oxide glass used as the positive electrode active material.

As the negative electrode active material, there can be used any known negative electrode active material that is capable of occlusion and release of lithium ions. Examples of such negative electrode active material include carbon materials represented by graphite, alloy materials such as TiSn alloys, TiSi alloys, etc., and oxides such as Li₄Ti₅O₁₂, LiTiO₄, etc. In addition, lithium metal foil may also be used. Besides, vanadium oxide glass can be used as the negative electrode active material, and by crystallizing at least part of the glass it is possible to enhance ion conductivity and electron conductivity. Where the vanadium oxide glass is used also as the negative electrode active material in the negative electrode active material layer, it is unnecessary to impart ferroelectricity to the vanadium oxide glass used as the negative electrode active material.

The solid electrolyte may not necessarily be specifically restricted so long as it is a solid electrolyte material that shows lithium ion conductivity; from the viewpoint of safety, however, the solid electrolyte is preferably an incombustible inorganic solid electrolyte. Examples of the solid electrolyte usable here include halogenated lithium such as LiCl, LiI, etc., sulfide glasses represented by Li₂S—SiS₂, Li₃PO₄—Li₂S—SiS₂, etc., oxide glasses represented by Li_{1.4}Al_{0.4}Ti_{1.6} (PO₄)₃, Li_{3.4}V_{0.6}Si_{0.4}O₄, etc., and perovskite oxides such as Li_{0.34}La_{0.51}TiO_{2.94}. Besides, the ion-conductive vanadium oxide glass can also be used as the solid electrolyte. Incidentally, in view of the fact that halogenated lithium and sulfide glasses are low in stability against water or oxygen, it is more preferable to use oxide materials as the solid electrolyte.

Now, a second embodiment (Example) of the present invention will be described in detail below, referring to the drawings as required. Note that the present invention is not limited to individual ones of the plurality of embodiments taken up here, and the embodiments may be combined with each other as required.

It was contemplated to secure sufficient ionic conduction paths between active material particles and solid electrolyte particles, thereby enhancing ion conductivity, to mix the active material particles and the solid electrolyte particles with ferroelectric substance particles and to fill up gaps between both of them with ion-conductive vanadium oxide glass, in order to restrain the formation of a space-charge layer or an electric double layer, thereby enlarging electrochemical potential gradient of ions. Specifically, the active material particles and the solid electrolyte particles are present mixedly with the ferroelectric substance particles, and both of them are bound by vanadium oxide glass, to form an electrode active material layer. Under the condition where the surfaces of the active material particles in contact with the vanadium oxide glass serve as ionic conduction paths, ions move between the active material particles and the vanadium oxide glass. Furthermore, under the condition where the surfaces of the solid electrolyte particles in contact with the vanadium oxide glass serve as ionic conduction paths, ions move between the vanadium oxide glass and the solid electrolyte particle. As a result, sufficient ionic conduction paths can be secured between the active material particles and the solid electrolyte particles, so that ion conductivity can be enhanced. Furthermore, by a dielectric polarization effect of the ferroelectric substance particles, the formation of a space-charge layer or an electric double layer at interfaces between the active material particles and the solid electrolyte particles is restrained, whereby electrochemical potential gradient of ions can be enlarged, so that ion conductivity is enhanced.

Like in the first embodiment, it suffices for the aforementioned configuration to be applied to either the positive electrode active material layer or the negative electrode active material layer. It is preferable that the aforementioned configuration is applied to both the positive electrode active material layer and the negative electrode active material layer.

FIG. 2 shows sectional views of a major part of an all-solid state ion secondary battery according to the second embodiment of the present invention. FIG. 2(a) is an overall view. A positive electrode active material layer 207 formed on a positive electrode collector 201 and a negative electrode active material layer 209 formed on a negative electrode collector 206 are joined to each other through a solid electrolyte layer 208, and the positive electrode active material layer and the negative electrode active material layer are perfectly electrically insulated by the solid electrolyte layer. Numeral 202 denotes positive electrode active material particles, 203 denotes vanadium oxide glass, 204 denotes solid electrolyte particles, and 205 denotes negative electrode active material particles.

FIGS. 2(b) and 2(c) are enlarged views of the positive and negative electrode active material layers. It is preferable that the active material particles 202, 205 and the solid electrolyte particles 204 and the ferroelectric particles 210 are bound to each other by the ion-conductive vanadium oxide glass 203, and that the ferroelectric particles are disposed between the active material particles and the solid electrolyte particles in order to enhance ion conductivity between the active material particles and the solid electrolyte particles.

Note that a conductive assistant may be added, like in the first embodiment.

The vanadium oxide glass in this embodiment contains vanadium, and at least one of tellurium and phosphorus as vitrifying component. Other than these, iron or tungsten may be added, whereby water resistance can be enhanced remarkably. In addition, in order to prevent a reaction from taking place between the active material particles and the solid electrolyte particles, it is preferable to set the softening point of the vanadium oxide glass to be not more than 500° C. Where ferroelectricity is to be imparted also to the vanadium oxide glass, it suffices to use the vanadium oxide glass of the first embodiment.

The amount of the vanadium oxide glass added according to the amount of the active material or the solid electrolyte is the same as in the first embodiment.

Besides, by crystallizing at least part of the vanadium oxide glass in the positive electrode active material layer, it is possible to enhance ion conductivity and electron conductivity.

The positive electrode active material, the negative electrode active material, and the solid electrolyte are the same as in the first embodiment.

Examples of the ferroelectric particles includes crystals of BaTiO₃, SrBi₂Ta₂O₉, (K, Na)TaO₃, (K, Na)NbO₃, BiFeO₃, Bi(Nd, La)TiOₓ, Pb(Zr, Ti)O₃, etc., but are not particularly limited. The size of the ferroelectric particles is preferably comparable to or smaller than those of the active material particles and the solid electrolyte particles. Besides, by preliminarily adhering the ferroelectric particles to surfaces of the active material particles or the solid electrolyte particles by a mechanofusion process, a mechanical alloying process, a sol-gel process or the like, it is possible to enhance the probability of the ferroelectric particles being disposed between the active material particles and the solid electrolyte particles.

Besides, the amount of the ferroelectric particles added is preferably such that assuming that the total content of the vanadium oxide glass and the ferroelectric particles is 100 vol %, the content of the ferroelectric particles is 5 to 40 vol %. When the content of the ferroelectric particles is not less than 5 vol %, a dielectric polarization action is generated and, therefore, lithium ionic conductivity is enhanced. In addition, when the content of the ferroelectric particles is not more than 40 vol %, the proportion of the vanadium oxide glass is sufficient and, therefore, lithium ionic conductivity is not likely to be lowered.

The present invention will be described specifically below, with reference to Examples.

### Example 1

### Preparation of Vanadium Oxide Glass

An ion-conductive and ferroelectric vanadium oxide glass A and a vanadium oxide glass B which is only ion-conductive were prepared. As raw materials, there were used vanadium pentoxide (V₂O₅), phosphorus pentoxide (P₂O₅), tellurium dioxide (TeO₂), ferric oxide (Fe₂O₃), barium carbonate (BaCO₃), and titanium dioxide (TiO₂). The raw material composition for the glass A, in terms of a molar ratio of raw materials, was V₂O₅:P₂O₅:TeO₂:Fe₂O₃:TiO₂:BaCO₃=36.2:10:23.1:7.7:11.5:11.5. The raw material composition for the glass B, in terms of a molar ratio of raw materials, was V₂O₅:P₂O₅:TeO₂:Fe₂O₃=55:14:22:9. The raw material powders were placed in platinum crucibles, and were heated by keeping them at 1,100° C. for 1 hour by use of an electric furnace. Incidentally, during the heating the raw materials in each of the platinum crucibles were stirred to be uniform. Thereafter, the platinum crucibles were taken out of the electric furnace, the melts in the crucibles were each let flow onto a stainless steel plate preliminarily heated at 150° C., followed by natural cooling, to obtain vanadium oxide glasses. The softening points of the glass A and the glass B measured by differential thermal analysis were 380° C. and 345° C., respectively. Besides, the glasses thus prepared were mechanically pulverized to an average particle diameter of about 3 μm.

### <Positive Electrode>

A LiCoO₂ powder having an average particle diameter of 5 μm as a positive electrode active material, the powder of the glass A prepared above, a Li_{1.5}Al_{0.5}Ti_{1.5} (PO₄)₃ powder (hereinafter described as LATP) having an average particle diameter of 3 μm as a solid electrolyte, and conductive titanium oxide (having rutile type titanium oxide as a base material coated with a Sb-doped SnO2 conductive layer) in an acicular form (minor axis: 0.13 μm, major axis: 1.68 μm) as a conductive assistant were mixed in a volume ratio of 53:30:10:7, and appropriate amounts of a resin binder and a solvent were added to the mixed powder, to prepare a positive electrode paste. Note that ethyl cellulose and nitrocellulose were used as the resin binder, and butylcarbitol acetate was used as the solvent. The positive electrode paste was applied to a 20 μm-thick aluminum foil. After a heat treatment for removing the solvent and the binder, the resulting coating was fired at 390° C. in atmospheric air for 1 hour, to obtain a positive electrode sheet with a positive electrode active material layer having a thickness of 10 μm. The positive electrode sheet was die-cut into a disk having a diameter of 14 mm, which was made to be a positive electrode.

### <Negative Electrode>

A Li₄Ti₅O₁₂ powder having an average particle diameter of 5 μm as a negative electrode active material, the power of the glass A prepared above, LATP having an average particle diameter of 3 μm as a solid electrolyte, and conductive titanium oxide (having rutile type titanium oxide as a base material coated with a Sb-doped SnO₂ conductive layer) in an acicular form (minor axis: 0.13 μm, major axis: 1.68 μm) as a conductive assistant were mixed in a volume ratio of 53:30:10:7, and appropriate amounts of a resin binder and a solvent were added to the mixed powder, to prepare a negative electrode paste. The negative electrode paste was applied to a 20 μm-thick aluminum foil. After a heat treatment for removing the solvent and the binder, the resulting coating was fired at 360° C. in atmospheric air for 1 hour, to obtain a negative electrode sheet with a negative electrode active material layer having a thickness of 10 μm. The negative electrode sheet was die-cut into a disk having a diameter of 14 mm, which was made to be a negative electrode.

Note that while the vanadium oxide glass used to form the positive electrode active material layer and the vanadium oxide glass used to form the negative electrode active material layer were the same in this Example, both of the glasses may not necessarily be of the same composition so long as they are ion-conductive and ferroelectric vanadium oxide glasses. This applies also to the following Examples.

### <Solid Electrolyte>

LATP having an average particle diameter of 3 μm as a solid electrolyte and the powder of the glass B prepared above were mixed in a volume ratio of 70:30, and appropriate amounts of a resin binder and a solvent were added to the mixed powder, to prepare a solid electrolyte paste. The solid electrolyte paste was applied to either the electrode layer of the positive electrode or the electrode layer of the negative electrode. Then, after a heat treatment for removing the solvent and the binder was conducted, the resulting coating was fired in atmospheric air at 390° C., which is a temperature higher than the softening point of the glass B, for 1 hour, to obtain a 15 μm-thick solid electrolyte layer. The resulting member was die-cut into a disk having a diameter of 15 mm.

The solid electrolyte layer is not limited to the one composed of a particulate solid electrolyte as in this Example, so long as the solid electrolyte layer is permeable to ions but impermeable to electrons. This applies also to the following Examples.

### <Fabrication of Battery>

The electrode layer with the solid electrolyte layer formed thereon as aforementioned and the other electrode layer were laminated on each other. To enhance adhesion at the interfaces in a positive electrode active material layer/solid electrolyte layer/negative electrode active material layer structure, the laminate was fired in atmospheric air at 350° C., which is higher than the softening point of the glass B and lower than the softening point of the glass A, while applying a pressure thereto, for 1 hour, to effect sufficient adhesion at the interfaces between the layers. A side surface of the laminate thus obtained was masked with an insulator, and the masked laminate was assembled into a CR2025 type coin cell battery, to fabricate an all-solid state battery.

Incidentally, in place of the aforementioned method of forming each of the layers by applying a paste of a mixed powder and firing the paste, there can be applied a cold spray (CS) process in which a mixed powder is, without being melted or gasified, made to collide against a substrate together with an inert gas in an supersonic stream while remaining in a solid phase, to form a coating film on the substrate. There can also be applied an aerosol deposition (AD) method in which an aerosol formed by mixing a mixed powder with a gas is jetted through a nozzle onto a substrate, while utilizing a gas flow generated by a pressure difference, to form a coating film on the substrate.

A battery fabricating method by the CS process will be described below. A mixed powder of the same LiCoO₂ powder as aforementioned, the glass A powder, the LATP powder, and the conductive titanium oxide was jetted onto a 20 μm-thick aluminum foil, to form a positive electrode active material layer having a thickness of 10 μm. Note that the powders may be charged respectively in separate feeders and be jetted simultaneously.

A mixed powder of the same LATP powder as aforementioned and the glass B powder prepared above was jetted onto the positive electrode active material layer, to form a solid electrolyte layer having a thickness of 15 μm.

Next, a mixed powder of the same Li₄Ti₅O₁₂ powder as aforementioned, the glass A powder, the LATP powder, and the conductive titanium oxide was jetted onto the solid electrolyte layer, to form a negative electrode active material layer having a thickness of 10 μm.

Furthermore, an aluminum powder is jetted onto the negative electrode electrolyte layer, to form a negative electrode collector layer having a thickness of 20 μm.

### Example 2

### Preparation of Vanadium Oxide Glass

Two kinds of ion-conductive vanadium oxide glasses differing in softening point were prepared. As raw materials, there were used vanadium pentoxide (V₂O₅), phosphorus pentoxide (P₂O₅), tellurium dioxide (TeO₂), and ferric oxide (Fe₂O₃). The raw material composition for a glass A having a higher softening point, in terms of the molar ratio of raw materials, was V₂O₅:P₂O₅:TeO₂:Fe₂O₃=47:13:30:10. The raw material composition for a glass B having a lower softening point, in molar ratio, was V₂O₅:P₂O₅:TeO₂:Fe₂O₃=55:14:22:9. The raw material powders were placed in platinum crucibles, and were heated by keeping at 1,100° C. for 1 hour by use of an electric furnace. Incidentally, during the heating the raw materials in each of the platinum crucibles were stirred to be uniform. Thereafter, the platinum crucibles were taken out of the electric furnace, and the melts in the crucibles were let flow onto a stainless steel plate preliminarily heated at 150° C., followed by natural cooling, to obtain vanadium oxide glasses. The softening points of the glass A and the glass B measured by differential thermal analysis were 356° C. and 345° C., respectively. Besides, the thus produced glasses were mechanically pulverized to an average particle diameter of about 3 μm.

### <Positive Electrode>

A LiCoO₂ powder having an average particle diameter of 5 μm as a positive electrode active material, the powder of the glass A prepared above, a Li_{1.5}A_{10.5}Ti_{1.5}(PO₄)₃ powder (hereinafter described as LATP) having an average particle diameter of 3 μm as a solid electrolyte, and conductive titanium oxide (having rutile type titanium oxide as a base material coated with a Sb-doped SnO₂ conductive layer) in an acicular form (minor axis: 0.13 μm, major axis: 1.68 μm) as a conductive assistant were mixed in a volume ratio of 50.4:28.5:9.5:6.6:5, and appropriate amounts of a resin binder and a solvent were added to the mixed powder, to prepare a positive electrode paste. Note that ethyl cellulose and nitrocellulose were used as the resin binder, and butylcarbitol acetate was used as the solvent. The positive electrode paste was applied to a 20 μm-thick aluminum foil. After a heat treatment for removal of the solvent and the binder, the resulting coating was fired at 360° C. in atmospheric air for 1 hour, to obtain a positive electrode sheet with a positive electrode active material layer having a thickness of 10 μm. The positive electrode sheet was die-cut into a disk having a diameter of 14 mm, which was made to be a positive electrode.

### <Negative Electrode>

A Li₄Ti₅O₁₂ powder having an average particle diameter of 5 μm as a negative electrode active material, the powder of glass A prepared above, LATP having an average particle diameter of 3 μm as a solid electrolyte, conductive titanium oxide (having rutile type titanium oxide as a base material coated with a Sb-doped SnO₂ conductive layer) in an acicular form (minor axis: 0.13 μm, major axis: 1.68 μm) as a conductive assistant, and BaTiO3 having an average particle diameter of 0.1 μm as ferroelectric particles were mixed in a volume ratio of 50.4:28.5:9.5:6.6:5, and appropriate amounts of a resin binder and a solvent were added to the mixed powder, to prepare a negative electrode paste. The negative electrode paste was applied to a 20 μm-thick aluminum foil. Then, after a heat treatment for removing the solvent and the binder, the resulting coating was fired at 360° C. in atmospheric air for 1 hour, to obtain a negative electrode sheet with a negative electrode active material layer having a thickness of 10 μm. The negative electrode sheet was die-cut into a disk having a diameter of 14 mm, which was made to be a negative electrode.

Note that while the vanadium oxide glass used for the positive electrode active material layer and the vanadium oxide glass used for the negative electrode active material layer were the same in this Example, both of the glasses may not necessarily be of the same composition so long as they are ion-conductive vanadium oxide glasses.

### <Solid Electrolyte Layer>

LATP having an average particle diameter of 3 μm as a solid electrolyte and the powder of the glass B prepared above were mixed in a volume ratio of 70:30, and appropriate amounts of a resin binder and a solvent were added to the mixed powder, to prepare a solid electrolyte paste. The solid electrolyte paste was applied to either the electrode layer of the positive electrode or the electrode layer of the negative electrode. Then, after a heat treatment for removing the solvent and the binder was conducted, the resulting coating was fired in atmospheric air at 350° C., which is a temperature higher than the softening point of the glass B, for 1 hour, to obtain a solid electrolyte layer. The resulting member was die-cut into a disk having a diameter of 15 mm.

The solid electrolyte layer is not limited to the one composed of a particulate solid electrolyte as in this Example, so long as the solid electrolyte layer is permeable to ions but impermeable to electrons.

### <Fabrication of Battery>

The method for fabricating a battery is the same as in Example 1.

### Comparative Example

### Positive Electrode

A LiCoO₂ powder having an average particle diameter of 5 μm as a positive electrode active material, polyvinylidene fluoride as a binder, LATP having an average particle diameter of 3 μm as a solid electrolyte, and conductive titanium oxide (having rutile type titanium oxide as a base material coated with a Sb-doped SnO₂ conductive layer) in an acicular form (minor axis: 0.13 μm, major axis: 1.68 μm) as a conductive assistant were mixed in a volume ratio of 53:30:10:7, and an appropriate amount of N-methyl-2-pyrrolidone (NMP) was added to the mixed powder, to prepare a positive electrode paste. The positive electrode paste was applied to a 20 μm-thick aluminum foil. After drying by heating in atmospheric air at 90° C. for 1 hour, the coated aluminum foil was pressed, to obtain a positive electrode sheet with a positive electrode active material layer having a thickness of 10 μm. The resulting member was die-cut into a disk having a diameter of 14 mm.

### <Negative Electrode Layer>

A Li₄Ti₅O₁₂ powder having an average particle diameter of 5 μm as a negative electrode active material, polyvinylidene fluoride as a binder, and conductive titanium oxide (having rutile type titanium oxide as a base material coated with a Sb-doped SnO₂ conductive layer) in an acicular form (minor axis: 0.13 μm, major axis: 1.68 μm) as a conductive assistant were mixed in a volume ratio of 53:30:10:7, and an appropriate amount of NMP was added to the mixed powder, to prepare a negative electrode paste. The negative electrode paste was applied to a 20 μm-thick aluminum foil. After drying by heating in atmospheric air at 90° C. for 1 hour, the coated aluminum foil was pressed, to obtain a negative electrode sheet with a negative electrode active material layer having a thickness of 10 μm. The negative electrode sheet was die-cut into a disk having a diameter of 14 mm.

### <Solid Electrolyte Layer>

LATP having an average particle diameter of 3 μm as a solid electrolyte and polyvinylidene fluoride as a binder were mixed in a volume ratio of 70:30, and an appropriate amount of NMP was added to the mixed powder, to prepare a solid electrolyte paste. The paste was applied to a 50 μm-thick polyimide sheet. After drying by heating in atmospheric air at 90° C. for 1 hour, the coated sheet was pressed, to obtain a solid electrolyte sheet having a thickness of 15 μm. The solid electrolyte sheet was die-cut into a disk having a diameter of 14 mm, and the coating film was separated from the polyimide sheet, to obtain a solid electrolyte layer.

### <Fabrication of Battery>

The positive electrode, the solid electrolyte layer and the negative electrode described above were laminated. To enhance adhesion at interfaces in the positive electrode layer/solid electrolyte layer/negative electrode layer structure, the laminate was subjected to a heat treatment in vacuum at 120° C. for 1 hour while exerting a pressure on the laminate, to effect sufficient adhesion at the interfaces between the layers. A side surface of the laminate obtained was masked with an insulator, and the masked laminate was assembled into a CR2025 type coin cell battery, to fabricate an all-solid state battery.

<Evaluation of battery characteristics>

For the batteries fabricated in Example 1, Example 2, and Comparative Example, discharge capacity was measured at rates of 0.1 C and 1 C. The measurement result is shown in Table 1.

It was made clear that the all-solid state lithium ion secondary batteries of Examples of the present invention are superior to the all-solid state lithium ion secondary battery of Comparative Example, in regard of rate characteristic and retention rate after charge-discharge cycles of battery discharge capacity. This is attributable to the fact that sufficient ionic conduction paths were secured between the active material particles and the solid electrolyte particles, since the gaps between the active material particles and the solid electrolyte particles were filled up with the ion-conductive and ferroelectric vanadium oxide glass. Besides, there was no difference between the results of Example 1 and the results of Example 2. Thus, it is seen that in the case where ferroelectric particles are dispersed in an ion-conductive vanadium oxide glass instead of using an ion-conductive and ferroelectric vanadium oxide glass, also, the same ion conductivity promoting effect as in the case of using the ion-conductive and ferroelectric vanadium oxide glass is produced.

TABLE 1

| | Discharge capacity at a | | Discharge capacity at a | |
|---|---|---|---|---|
| | rate of 0.1 C (mAh/g) | | rate of 1 C (mAh/g) | |
| | Initial | After 20 cycles | Initial | After 20 cycles |
| Example 1 | 130 | 125 | 100 | 95 |
| Example 2 | 125 | 120 | 95 | 90 |
| Comparative | 80 | 40 | 30 | 15 |
| Example | | | | |

### DESCRIPTION OF REFERENCE NUMERALS

101, 201: Positive electrode collector
102, 202: Positive electrode active material particles
103, 203: Vanadium oxide glass
104, 204: Solid electrolyte particles
105, 205: Negative electrode active material particles
106, 206: Negative electrode collector
107, 207: Positive electrode active material layer
108, 208: Solid electrolyte layer
109, 209: Negative electrode active material layer
210: Ferroelectric particles

1. An all-solid state ion secondary battery comprising a solid electrolyte layer joined between a positive electrode active material layer and a negative electrode active material layer,
wherein at least one of the positive electrode active material layer and the negative electrode active material layer is formed by binding active material particles and solid electrolyte particles together through an ion-conductive and ferroelectric substance.

2. The all-solid state ion secondary battery according to claim 1,
wherein the ion-conductive and ferroelectric substance is a vanadium oxide glass.

3. The all-solid state ion secondary battery according to claim 2,
wherein at least part of the vanadium oxide glass is crystallized.

4. The all-solid state ion secondary battery according to claim 2,
wherein the vanadium oxide glass contains at least one of tellurium and phosphorus and contains at least one selected from the group consisting of titanium, barium, bismuth, tantalum, niobium, zirconium, lead, and iron.

5. The all-solid state ion secondary battery according to claim 2,
wherein the vanadium oxide glass contains crystal of at least one selected from the group consisting of BaTiO₃, SrBi₂Ta₂O₉, (K, Na) TaO₃, (K, Na) NbO₃, BiFeO₃, Bi (Nd, La)TiOₓ, and Pb(Zr, Ti)O₃.

6. The all-solid state ion secondary battery according to claim 2,
wherein the vanadium oxide glass has a softening point of not more than 500° C.

7. The all-solid state ion secondary battery according to claim 1,
wherein the ion-conductive and ferroelectric substance contains a vanadium oxide glass and ferroelectric particles.

8. The all-solid state ion secondary battery according to claim 7,
wherein at least part of the vanadium oxide glass is crystallized.

9. The all-solid state ion secondary battery according to claim 7,
wherein the vanadium oxide glass contains at least one of tellurium and phosphorus.

10. The all-solid state ion secondary battery according to claim 7,
wherein the ferroelectric particles contain at least one selected from the group consisting of BaTiO₃, SrBi₂Ta₂O₉, (K, Na)TaO₃, (K, Na)NbO₃, BiFeO₃, Bi(Nd, La)TiOₓ, and Pb(Zr, Ti)O₃.

11. The all-solid state ion secondary battery according to claim 7,
wherein the vanadium oxide glass has a softening point of not more than 500° C.
